(19) United States
(12) Patent Application Publication
(10) Pub. No.: US 2017/0091389 A1
(43) Pub. Date: Mar. 30, 2017

(54) Open Healthcare Data Platform

(71) Applicant: Accenture Global Services Limited, Dublin (IE)

(72) Inventor: Carl Matthew Dukatz, San Jose, CA (US)

(21) Appl. No.: 14/870,783

(22) Filed: Sep. 30, 2015

(51) Int. Cl. G06F 19/00

(52) U.S. Cl. CPC G06F 19/322

(57) ABSTRACT

Methods, systems, and apparatus, including computer programs encoded on a computer storage medium, for an open healthcare data platform are disclosed. In one aspect, a method includes receiving a request for access to healthcare related data that is associated with one or more healthcare related parameters.

The method further includes determining that a user's personal healthcare related data that is shared with a healthcare provider that provides services to the user corresponds to the one or more healthcare related parameters. The method further includes providing a request for access to the user's personal healthcare related data. The method further includes receiving data indicating an acceptance of the request for access to the user's personal healthcare related data and data indicating a level of abstraction. The method further includes processing the user's personal healthcare related data that is shared with the healthcare provider according to the level of abstraction.

### TECHNICAL FIELD

This application generally relates to data sharing and data access, and more specifically, to providing access to healthcare data.

### BACKGROUND

Patients may use several devices to collect healthcare related data and to download that data into a central repository. Once downloaded, healthcare providers may be able to view the healthcare related data by logging into the central repository. The devices may include a blood sugar monitor, blood pressure monitor, scale, pedometer, etc. The central repository may require the healthcare provider to log into the system so that the healthcare provider may view the data for the provider's patients.

### SUMMARY

When a healthcare researcher begins a healthcare related research project, the healthcare researcher may solicit volunteers to participate in a research study so that the healthcare researcher can gather data. For example, the researcher may place flyers near where potential volunteers may be such as a hospital. A potential volunteer may see a flyer, contact the researcher, and then provide the researcher with the requested healthcare related information. The pool of volunteers may be limited by the researchers ability to place flyers or to otherwise identify who the likely volunteers are or where the likely volunteers may be located.

Instead of searching for volunteers by posting flyers, the researcher may request healthcare related data directly from an open healthcare data platform that securely stores patient healthcare related data. The open healthcare data platform stores healthcare related data that a healthcare provider requests that a patient begin collecting. Examples of healthcare related data that a healthcare provider may request that a patient begin to collect include blood sugar data, blood pressure data, step count data, weight, or any other type of healthcare related information. The healthcare provider may then log into the open healthcare data platform to view the patient's progress.

To request healthcare related data from the open healthcare data platform, the researcher submits a request to the open healthcare data platform for a type of healthcare related data. The platform analyzes the data for each patient and identifies the patients who have stored data that matches the researcher's request. The platform notifies each patient that a researcher wishes to access the patient's healthcare related information and provides the patient with a description of the project that the researcher is pursuing, as provided by the research. The patient has the option of fully complying or partially complying with the request by selecting only the healthcare related data, demographic data, and other identifying information that the patient is comfortable sharing with the researcher. The open healthcare data platform then processes the patient's healthcare related data according to the patient's request and provides the processed healthcare related data to the researcher.

An innovative aspect of the subject matter described in this specification may be implemented in a method that includes the actions of receiving, from a third party, a request for access to healthcare related data that is associated with one or more healthcare related parameters; determining that a user's personal healthcare related data that is shared with a healthcare provider that provides services to the user corresponds to the one or more healthcare related parameters; based on determining that the user's personal healthcare related data that is shared with the healthcare provider that provides services to the user corresponds to the one or more healthcare related parameters, providing, to the user, a request for access to the user's personal healthcare related data that is shared with the healthcare provider; receiving, from the user, data indicating an acceptance of the request for access to the user's personal healthcare related data that is shared with the healthcare provider and data indicating a level of abstraction to apply to the user's personal healthcare related data that is shared with the healthcare provider; processing the user's personal healthcare related data that is shared with the healthcare provider according to the level of abstraction; and providing, to the third party, the processed user's personal healthcare related data that is shared with the healthcare provider.

These and other implementations can each optionally include one or more of the following features. The request for access to healthcare related data that is associated with one or more healthcare related parameters includes a summary of a use for the healthcare related data, and a level of compensation to provide to users who provide the healthcare related data. The one or more healthcare related parameters includes a category of the healthcare related data and a level of detail that specifies a frequency of collection of the category of the healthcare related data. The data indicating a level of abstraction to apply to the user's personal healthcare related data that is shared with the healthcare provider comprises data indicating whether to include the user's name, the user's demographic information, and the user's geographic location with the user's personal healthcare related data that is shared with the healthcare provider. The user's personal healthcare related data that is shared with the healthcare provider includes data received from a pedometer; data received from a blood sugar monitor; data received from a scale; data received from a blood pressure monitor; data received from a pulse monitor; and data received from a thermometer. The data indicating the acceptance of the request for access to the user's personal healthcare related data that is shared with the healthcare provider comprises data indicating a filter to apply to the user's personal healthcare related data according to a periodic frequency.

The actions further include receiving, from a fourth party, an additional request for access to healthcare related data that is associated with the one or more healthcare related parameters; providing, to the user, an additional request for access to the user's personal healthcare related data that is shared with the healthcare provider; receiving, from the user, data indicating an acceptance of the additional request for access to the user's personal healthcare related data that is shared with the healthcare provider and data indicating a second, different level of abstraction to apply to the user's personal healthcare related data that is shared with the healthcare provider; processing the user's personal healthcare related data that is shared with the healthcare provider according to the second, different level of abstraction; and providing, to the fourth party, the user's personal healthcare related data that is shared with the healthcare provider and that is processed according to the second, different level of abstraction. The user's personal healthcare related data that is shared with the healthcare provider is received from a quantified self device, and the data indicating the acceptance of the request for access to the user's personal healthcare related data that is shared with the healthcare provider and data indicating a level of abstraction to apply to the user's personal healthcare related data that is shared with the healthcare provider is received from the quantified self device.

Other implementations of this aspect include corresponding systems, apparatus, and computer programs recorded on computer storage devices, each configured to perform the operations of the methods.

Particular implementations of the subject matter described in this specification can be implemented so as to realize one or more of the following advantages. A system may allow a third party to access healthcare related data for patients as authorized by each patient.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example system for receiving and sharing healthcare related data with a healthcare provider and a third party.

FIG. 2 is an example user interface for a third party to request healthcare related data.

FIG. 3 is an example user interface for a patient to view collected healthcare related data and corresponding healthcare providers.

FIG. 4 is an example user interface of third party requests for healthcare related data.

FIG. 5 is an example user interface for a patient to select healthcare related data to share with a third party.

FIG. 6 is an example user interface of a patient dashboard.

FIG. 7 is a flow chart of an example process for an open healthcare data platform.

FIG. 8 illustrates an example of a computing device and a mobile computing device.

Like reference numbers and designations in the various drawings indicate like elements.

### DETAILED DESCRIPTION

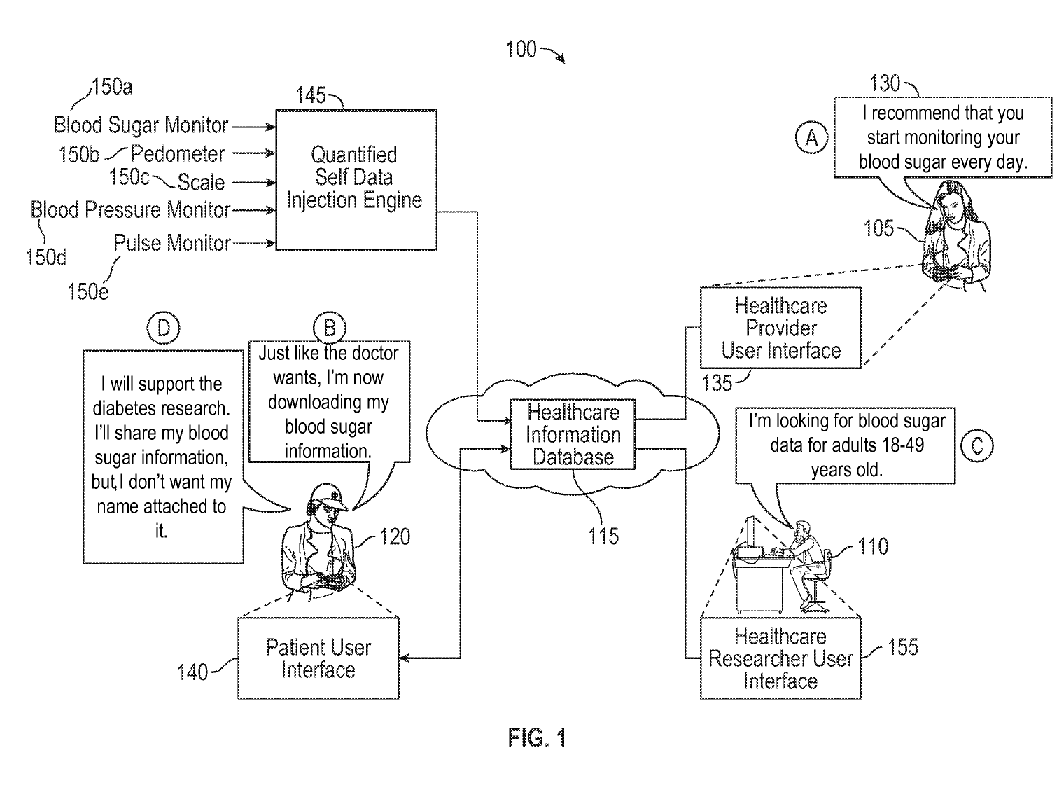

FIG. 1 is an example system 100 for receiving and sharing healthcare related data with a healthcare provider 105 and a third party 110. Briefly, and as described in further detail below, the healthcare information database 115 stores healthcare related data for the patient 120 as well as other patients. The healthcare information database 115 provides the healthcare provider 105 with access to the healthcare related data for patient 120. The healthcare information database 115 also provides the third party 110 access to the healthcare related data for the patient 120 as permitted by the patient 120.

In the example shown in FIG. 1, the healthcare provider 105 provides the patient 120 with a recommendation 130 to begin collecting healthcare related data as shown in stage A. The healthcare provider 105 may provide the recommendation to the patient 120 in person, over the telephone, or through some type of electronic means such as text, email, or instant message. In some implementations, the healthcare information database 115 may receive and transmit the recommendation from the healthcare provider 105 to the patient 120. The healthcare provider 105 may provide the recommendation 130 through the healthcare provider user interface 135 of the healthcare information database 115, and the patient 120 may receive the recommendation 130 through the patient user interface 140 of the healthcare information database 115. The recommendation 130 may be a recommendation to begin collecting healthcare related data. For example, the recommendation 130 may be for the patient 120 to begin collecting blood sugar data on a daily basis.

In stage B, the patient acts 120 on the healthcare provider's recommendation 130 and begins collecting the requested healthcare related data. For example, the patient 120 may begin collecting blood sugar data every day. To store the healthcare related data, the patient 120 may enter the data manually into the patient user interface 140. If the healthcare device 150 that collects the healthcare related data is configured to connect to the healthcare information database 115, then the healthcare device may download the healthcare related data automatically to the healthcare information database 115.

To transmit healthcare related data to the healthcare information database 115, healthcare devices 150 connect through the quantified self-data ingestion engine 145. The quantified self-data injection engine 145 is an interface between the healthcare information database 115 and healthcare devices 150 such as a blood sugar monitor 150a, pedometer 150b, scale 150c, blood pressure monitor 150d, and a pulse monitor 150e. The healthcare devices 150, or quantified self devices 150, may transmit healthcare related information to the quantified self-data injection engine 145 through a wired or wireless connection on a periodic basis or each time the healthcare device 150 collects data from the patient 120. In some implementations, the healthcare device 150 may be the same device that the patient 120 uses to access the patient user interface 140. For example, the patient 120 may access the patient user interface 140 on a mobile phone through a native application or through an application running in a browser of the mobile phone. The patient 120 may use that same mobile phone as a pedometer. The mobile phone would then access the quantified self data injection engine 145 to upload the patient's step count.

To begin the healthcare data collection process, the patient 140 may create an account on the healthcare information database 115 through the patient user interface 140. The patient 140 may enter the patient's name, demographic data such as gender, birthdate, and race, healthcare providers, and other healthcare related information. Alternatively, the healthcare provider 105 may create an account on the healthcare information database 115 through the healthcare provider user interface 135. The healthcare provider 105 may enter the patient's information such as the patient's name, demographic data, and requested healthcare data for the patient to collect. Because the patient's healthcare provider 105 requested the patient's account and the healthcare data collection, the healthcare provider will have access to the patient's healthcare related data.

Once the patient 120 has an account on the healthcare information database 115, the patient 120 may link the healthcare device 150 to the patient's account. For example, the patient 120 may link the blood sugar monitor 150a to the patient's account on the healthcare information database 115. Each time the patient 120 measures the patient's blood sugar, the blood sugar monitor 150a transmits the reading to the healthcare information database 115 through the quantified self-data injection engine 145. The quantified self-data injection engine 145 matches the data from the blood sugar monitor 150a to the patient's account and stores the data in the healthcare information database 115. The stored healthcare data is then accessible by the healthcare provider 105.

In stage C, the third party 110 submits a request to the healthcare information database 115 through the healthcare researcher user interface 155. The third party 110 may be a researcher conducting medical research, a developer who is developing a healthcare related application, or another third party. The request may be a request for a particular type of healthcare related data. For example, the third party 110 may request blood sugar data for adults ages 18-49. Along with the request for data, the third party may submit a description of the purpose of the request and the level of detail of healthcare data that the third party 110 is requesting. For example, the third party 110 may request daily blood sugar readings.

The healthcare information database 115 receives the request from the third party 110 and identifies patients who have stored data in the healthcare information database 115 that matches the request. For example, the third party 110 requested daily blood sugar data for adults ages 18-49, and the healthcare information database 115 identifies, among other users, patient 120, as a user who has stored that corresponding information on the healthcare information database 115. In stage D, the healthcare information database 115 presents, through the patient user interface 140, the patient 120 with an invitation to share the patient's blood sugar data with the third party 110. The patient's blood sugar data is already accessible by the healthcare provider 105, and at this point, the patient 120 has the option of making the patient's blood sugar data accessible to the third party 110.

In some implementations, the healthcare information database 115 is a centralized server or group of servers or computing devices that receives and transmits data through the internet. In some implementations, the healthcare information database 115 is a cloud service that receives and transmits data through the internet. In some implementations, the healthcare information database 115 is provided as software as a service.

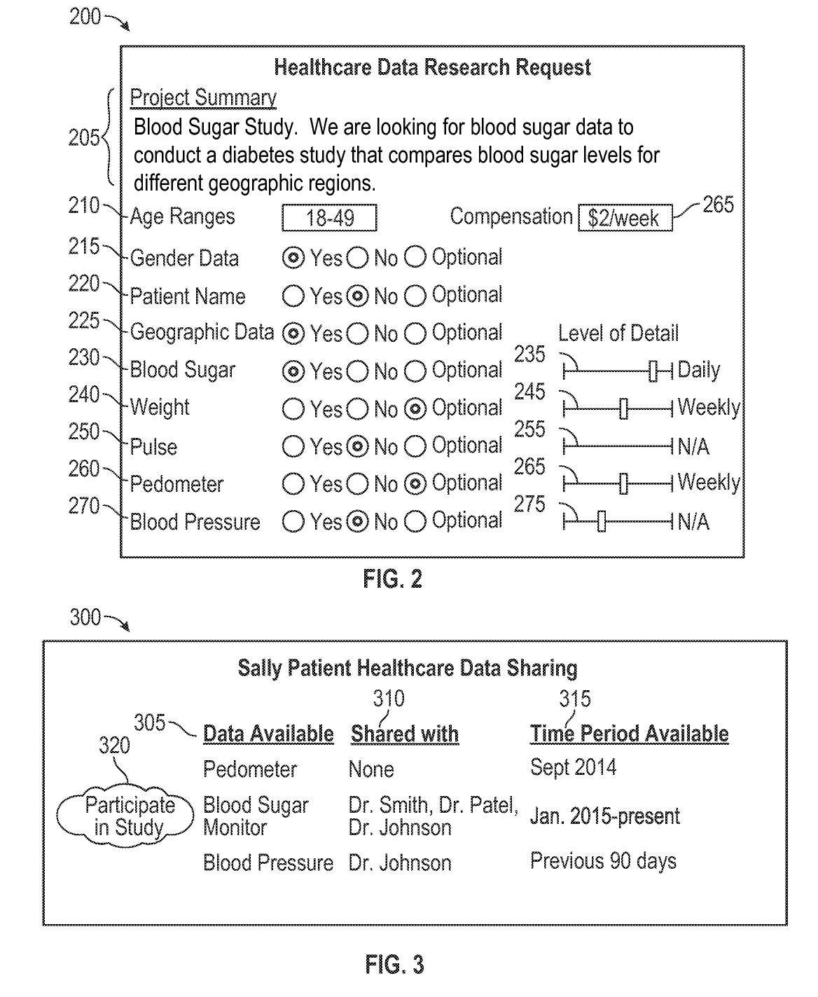

FIG. 2 is an example user interface 200 for a third party to request healthcare related data. The user interface 200 may correspond to the user interface that the third party 110 sees on the healthcare researcher user interface 155 while the third party is requesting healthcare related data from the healthcare information database 115. In some implementations, the healthcare information database 115 may require the third party 110 to setup an account with the healthcare information database 115 before the third party 110 submits a request for healthcare related data. In some implementations, the healthcare information database 115 will verify the identity of the third party 110. For example, if the third party claims to be a research from a university, then the healthcare information database 115 may cross check other databases to verify that claim.

The user interface 200 includes a summary input section 205 where the third party can type a summary of the purpose of the reason the third party is going to be using the healthcare related data. As an example, the third party may input that the third party is working on a research study for diabetes and is in search of blood sugar related data. In addition to typing in a summary, the summary input section 205 may allow for the third party to include an image, an audio file, a video file, or another type of multimedia file.

The user interface 200 includes different types of data that the third party may select in requesting the healthcare related data. The user interface 200 may only show those categories that the third party is authorized to request. For example, the third party may not be authorized to request patient names. In this instance, the user interface 200 may not show the option for the third party to request patient names.

The user interface 200 includes an age range selection option 210. The age range selection option 210 allows the third party to input the desired age range of the patients. For example, the third party may request healthcare related data for ages 18-49. The user interface 200 includes a gender selection option 215. The gender selection option 215 allows the third party to input whether the third party is seeking to collect the gender of each patient. The gender selection option 215 includes three radio buttons for the third party to select. The “yes” button allows the third party to specifically request that the patient include the patient's gender when granting access to the patient's healthcare related data. The “no” button allows the third party to specifically not request that the patient include the patient's gender when granting access to the patient's healthcare related data. The third party may specifically request that the patient omit certain information because the third party may be subject to different regulations regarding the safe keeping of the healthcare related data. The “optional” button allows the third party to optionally request that the patient include the patient's gender when granting access to the patient's healthcare related data.

The user interface 200 includes a patient name selection option 220. The patient name selection option 220 allows the third party to request that the patient select to attach the patient's name to the patient's healthcare related data. Similar to the gender selection option 215, the patient name selection option 220 includes “yes,” “no,” and “optional.” The user interface 200 includes a geographic data selection option 225. The geographic data selection option 225 allows the third party to request that the patient select to attach the patient's geographic location to the patient's healthcare related data. The patient's geographic data may include city, county, zip code, state, country, province, region, address, or other geographic identifier. Similar to the gender selection option 215, the geographic data selection option 225 includes “yes,” “no,” and “optional.”

The user interface 200 includes blood sugar selection option 230. The blood sugar selection option 230 allows the third party to request that the patient select to share the patient's blood sugar data. Similar to the gender selection option 215, the blood sugar selection option 230 includes “yes,” “no,” and “optional.” The blood sugar selection option 230 also includes a blood sugar level of detail scale 235. The blood sugar level of detail scale 235 allows the third party to select a level of detail of blood sugar readings that the third party is requesting the patient share. For example, the third party may set the blood sugar level of detail scale 235 to “daily” to request that the patient share daily blood sugar readings.

The user interface 200 includes weight selection option 240 and corresponding weigh level of detail scale 245, pulse selection option 250 and corresponding pulse level of detail scale 255, pedometer selection option 260 and corresponding pedometer level of detail scale 265, and blood pressure selection option 270 and corresponding blood pressure level of detail scale 275. These selection options and corresponding level of detail scales operate in a similar manner to the blood sugar selection option 230 and corresponding blood sugar level of detail scale 235. In some implementations, the selection options displayed on the user interface only correspond to those healthcare care related data items that the third party is authorized to access. For example, if the third party is not authorized to access blood pressure data, then the blood pressure selection option 270 and corresponding blood pressure level of detail scale 275 will not appear on the third party's user interface 200. The access authorization may be based on the type of third party, a researcher may have access to more data than a commercial application developer, or on the reason for the healthcare related data request, a research reason may provide access to more data than a commercial reason.

The level of detail scales may be inactive depending on the selection of the radio buttons on the corresponding selection option. For example, the pulse level of detail scale 255 may be inactive because the third party selected the “no” radio button for the pulse selection option 250. In some implementations, the level of detail scales may be limited. For example, a third party conducting research may be able to request pedometer data on at least a daily basis. A third party engaged in commercial activity may be able to request only at a highest frequency of every week.

The user interface 200 includes a compensation selector 280. The compensation selector 280 allows the third party to input a compensation amount to provide to each patient in exchange for the patient providing the patient's healthcare related data. In some implementations, the third party may only provide compensation to the patients who provide all of the required healthcare related data. For example, if the third party requires daily blood sugar readings, gender data, and geographic data, then the third party may choose to only provide compensation to those patients who provide those pieces of healthcare related data. In some implementations, the third party may choose to provide different levels of compensation depending on the amount of data that each patient is willing to provide. A third party may be willing to provide a higher compensation to a patient who provides more healthcare related data.

FIG. 3 is an example user interface 300 for a patient to view collected healthcare related data and corresponding healthcare providers. The user interface 300 may correspond to the user interface that the patient 120 sees on the patient user interface 140 while the patient is accessing the healthcare information database 115.

Once the third party places a request for a particular type of healthcare related data, the healthcare information database 115 searches the patient data to identify those patients who match the profile requested by the third party and who have collected the healthcare related data requested by the third party. The patients who are already collecting the healthcare related data are likely doing so in response to a request from the patient's healthcare provider. The healthcare information database 115 then provides a notification to the identified patients and invites each of the patients to share their healthcare related data with the third party. The healthcare information database may transmit the invitation to the user through an email, phone call, text message, or other messaging application or through the patient user interface as illustrated in user interface 300.

The user interface 300 illustrates the healthcare related data that Sally Patient is sharing with her healthcare providers. The user interface 300 includes a data available section 305 that illustrates the healthcare related data that is stored on the healthcare information database for Sally Patient. The healthcare related data that is stored on the healthcare information database for Sally Patient includes pedometer data, blood sugar data, and blood pressure data. The sharing section 310 illustrates the healthcare providers who currently have access to the corresponding healthcare related data for Sally Patient. For example, no health care providers have access to the pedometer data. Dr. Smith, Dr. Patel, and Dr. Johnson each have access to the blood sugar data. Dr. Johnson has access to the blood pressure data. The time available section 315 illustrates the amount of data collected for each corresponding type of healthcare related data. For example, the amount of pedometer data collected is from September 2014 to March 2015. The amount of blood sugar data collected is from January 2015 to the present day. The amount of blood pressure data collected is from the previous 90 days.

The user interface 300 includes sharing notification 320. The sharing notification 320 represents an attempt by the healthcare information database to connect the third party with a patient who has the requested information stored on the healthcare information database. In this example, the healthcare information database received a request for blood sugar data from patients age 18-49 as illustrated in FIG. 2. The healthcare information database identified the patients with the matching data and Sally Patient is one of those patients. The healthcare information database places a sharing notification 320 next to the healthcare related data that matches the request. Because the third party request was for blood sugar data, the sharing notification is located next to the blood sugar entry.

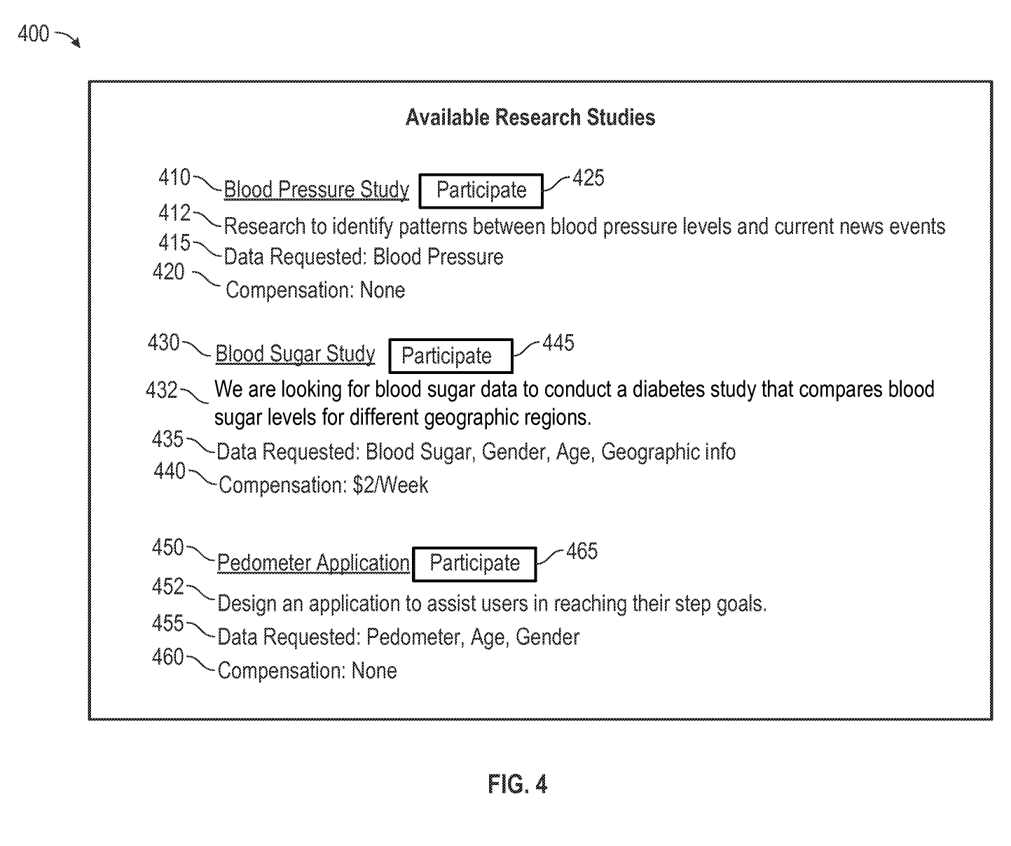

FIG. 4 is an example user interface 400 of third party requests for healthcare related data. The user interface 400 may correspond to the user interface that the patient 120 sees on the patient user interface 140 after the patient selected the sharing notification 320 on the user interface 300. The user interface 400 includes a list of available opportunities for the patient to share the patient's healthcare related data with third parties.

The user interface 400 includes descriptions for sharing opportunities that correspond to healthcare related data that the patient has stored on the healthcare information database. In some implementations, the user interface 400 may include sharing opportunities that only correspond to healthcare related data that the patient is already collecting for sharing with a healthcare provider. In some implementations, the user interface 400 may include sharing opportunities where the third party specified a demographic profile that matches the patient's demographic profile, but where the patient is not currently collecting the requested healthcare related information. In this implementation, the patient may begin collecting the healthcare related information for sharing with the third party. The newly collected healthcare related information may still be available for viewing by the patient's healthcare providers.

In the example shown in user interface 400, the patient may select from sharing opportunities 410, 430, and 450. The sharing opportunity 410 corresponds to a blood pressure study. The sharing opportunity 410 includes a description of the study 412 that the third party entered in the research request. The sharing opportunity 410 also includes a list of the data requested 415 by the third party and any compensation offered 420 by the third party. As shown in sharing opportunity 410, the data requested is blood pressure data and the compensation is zero. In some implementations, additional requested data is listed. For example, the sharing opportunity 410 may include a list of requested demographic information and an indication of whether or not the third party requested the patient's name. The sharing opportunity 410 also includes a participate button 425. Selecting the participate button 425 causes the patient user interface to display a user interface with more details regarding the healthcare data sharing opportunity.

The sharing opportunities 430 and 450 include similar fields to the sharing opportunity 410 and both include participate buttons 445 and 465. The sharing opportunity 430 for a blood sugar study includes a description of the study 432 that specifies the study is for diabetes research, the data requested 435 includes blood sugar data and various demographic data, and the compensation offered 440 is two dollars per week. The sharing opportunity 450 for a pedometer application includes a description of the study 452 that specifies the data will be used for design of an application to assist users in reaching step count goals, the data requested 455 includes pedometer data and various demographic data, and the compensation offered 460 is zero.

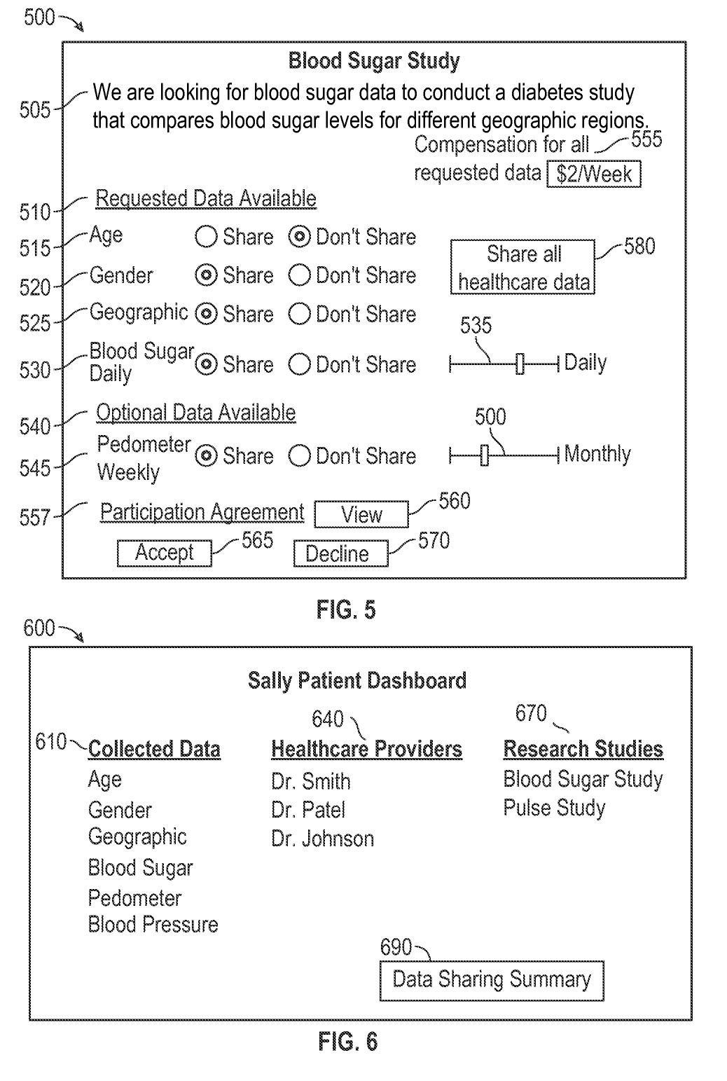

FIG. 5 is an example user interface 500 for a patient to select healthcare related data to share with a third party. The user interface 500 may correspond to the user interface that the patient 120 sees on the patient user interface 140 after the patient selected the participate button 445 on the user interface 400. The user interface 500 includes a more detailed description of the healthcare related data sharing opportunity selected in user interface 400.

The user interface 500 includes a summary 505 that describes the purpose of the healthcare related data sharing opportunity. In this example, the summary 505 is the summary 205 entered by the third party in user interface 200 and describes that the healthcare related data will be used in a diabetes study. The user interface 500 includes a requested data section 510. The requested data section 510 lists the healthcare related data that the third party is requesting and provides radio buttons for the patient to share the data or not share the data. In the example shown in user interface 500, the third party requested that the patient share age data 515, gender data 520, geographic data 525, and blood sugar data 530 by selecting the appropriate radio button. The blood sugar data option includes a level of detail scale 535 similar to the level of details scales from user interface 200. The blood sugar data option includes an indication that the third party requested daily blood sugar readings. To select the level of detail, the patient moves the slider bar of the level of detail scale 535. As shown in user interface 500, the patient has selected to share daily blood sugar readings. Regarding the other requested data, the patient, through user interface 500, has selected to share gender data and geographic data but not age data.

The user interface 500 includes an optional data section 540. The optional data section 540 lists the healthcare related data that the third party is optionally requesting and provides radio buttons for the patient to share the data or not share the data. In the example shown in user interface 500, the third party optionally requested that the patient share pedometer data 545 at a frequency of once per week. The pedometer data option includes a level of detail scale 550. The patient may slide the bar along the level of detail scale 550 to select the level of detail to share with the third party. The patient has set the level of detail scale 550 to share monthly pedometer counts.

The selections from the required data section 510 and the optional data section 540 may be referred to as a level of abstraction. The level of abstraction describes the amount of data that is removed from the original data stored in the healthcare information database. For example, the data that is related to blood sugar and that stored in the healthcare information database for the patient may be semi-daily blood sugar readings. The healthcare information database may also include the patient's name, gender, age, and address. In deciding what data to remove before sharing the blood sugar data with the third party, the patient applies a level of abstraction that may include removing age data and only sharing daily blood sugar readings. When the patient shares only a portion of data with a third party, the healthcare information database may average the readings within the shared frequency, select the first reading in the period, select the middle reading in the period, or select the last reading in the period. For example, if the patient has semi daily blood sugar readings and selects to share daily blood sugar readings, the healthcare information database may then average the two daily readings and share the average with the third party. For data such as pedometer data, the healthcare information database totals the data during the shared period. For example, if the patient collected daily step counts and chose to share weekly step counts, then the healthcare information database would total the step counts for each week and share the weekly total with the third party.

The user interface 500 includes compensation section 555. The compensation lists the compensation that is provided to the user by the third party for sharing healthcare related data with the third party. The compensation section 555 may indicate whether the compensation is provided to the patient for full compliance with sharing the requested healthcare related data or whether partial compensation is provided to the patient for partial compliance with sharing the requested healthcare related data. As shown in user interface 500, the compensation for sharing healthcare related data with the third party is two dollars per week. In some implementations, the compensation section 555 may adjust as the user chooses to share more or less healthcare related data. For example, when the third party only provides compensation for sharing all the requested data, the compensation section 555 shows zero unless all the requested healthcare related data sections are selected. When the third party provides partial compensation, the compensation section 555 shows a percentage of the maximum compensation inputted by the third party based on how many of the requested healthcare related data sections are selected.

The user interface 500 includes participation agreement section 557. The participation agreement section 557 includes a participation agreement view button 560, a participation accept button 565, and a participation decline button 570. Selecting the participation agreement view button 560 displays the legal agreement between the patient and the third party and the responsibilities of each party and of the healthcare information database. Once the patient is satisfied with the healthcare related data that he patient selected to share with the third party and with the participation agreement, the patient may select the participation accept button 565. At any point when interacting with the user interface 500, the patient may select the participation decline button 570 to exit the user interface 500 without choosing to share any healthcare related information with the third party.

In some implementations, the healthcare related data sharing may be tied to a particular time period. For example, the third party may only request healthcare related data for a six month period. In this instance, the patient who has six months of requested data already collected may select to share the requested portion only from previously collected data or only from data collected in the future or a combination of the two. A patient who has two months collected may select to share the previous two months and the next four months of data. The third party may request that the healthcare related data be from a particular time period. For example, the third party may request that the day be no older than one month or be healthcare related data that is collected in the future.

In some implementations, the user interface 500 includes an option for the patient to share all the patient's healthcare related data with the third party. By selecting button 580, the radio buttons for the demographic and healthcare related data may shift to the “share” option. Additionally, the features of the button may change to indicate that button 580 is currently selected. Alternatively, the user interface 500 may gray-out the radio buttons for the demographic and healthcare related data upon selection of the button 580, and the button 580 may be two radio buttons that are labeled “share all data” or “don't share all data.” The level of detail scales may no longer be active once the user selects the button 580. To not share all the healthcare related data, the patient may again select button 580 and then adjust the radio buttons. In some implementations, the user interface 200 may include an option for the third party to select where the third party can request the patient to be able to share all the patient's healthcare related data. By selecting the option in user interface 200, the button 580 appears in user interface 500. Including button 580 in user interface 500 may be a default portion or not a default portion of the user interface 500.

FIG. 6 is an example user interface 600 of a patient dashboard. The user interface 600 may correspond to the user interface that the patient 120 sees on the patient user interface 140 after the patient selected the participation accept button 565 of the participation decline button 570 on the user interface 500. The user interface 600 includes a patient dashboard with a summary of the patient's collected healthcare related data, the patient's healthcare providers, and the patient's third party sharing activities.

The user interface 600 displays a summary of the patient's activities with the healthcare information database. The user interface may include a collected healthcare data section 610, a healthcare providers section 640, and a third party sharing activities section 670. The collected healthcare data section 610 lists the healthcare related data that the patient has collected and stored on the healthcare information database. For example, the collected healthcare data section 610 may list data for age, gender, geographic location, blood sugar, pedometer data, and blood pressure data. Selecting any of the items in the collected healthcare data selection 610 may display another user interface that illustrates the selected collected healthcare data. For example, selecting the pedometer item may cause the user interface to display a graphical interface displaying the step count for each day for the previous six months.

The healthcare providers section 640 lists the healthcare providers who have access to the collected healthcare data listed in collected healthcare data section 610. Selecting one of the healthcare providers may display information related to the healthcare provider such as the provider's office location, previous and future appointments, healthcare related data that the healthcare provider requested and that the patient has collected, and healthcare related data that the healthcare provider requested and that the patient has not collected. In some implementations, if one of the patient's healthcare providers recommends that the patient collect an additional piece of healthcare related data, then the healthcare provider's name may appear in a different color or an icon may appear next to the healthcare provider's name indicating that the healthcare provider has requested that the patient begin collecting additional healthcare related data.

The third party sharing activities section 670 lists the third party sharing activities in which the patient is actively engaged or in which the patient has already participated. As shown in the third party sharing activities section 670, the patient is engaged in a blood sugar study and a pulse study. Selecting one of the third party sharing activities may display an interface that indicates the healthcare related data that is currently being shared with the third party. The interface may include a mechanism for the patient to adjust the healthcare related data sharing for the selected sharing activity. For example, selecting the blood sugar study from the third party sharing activities section 670 may display an interface similar to the user interface 500.

The user interface 600 may include a data sharing summary button 690. Selecting the data sharing summary button may cause the user interface 700 to transition to an interface that summarizes all of the data sharing activities of the patient. For example, the interface may include a graphical interface displaying the shared healthcare related data from the blood sugar study and the pulse study. The interface may include the third party who has access to different portions of the healthcare related data.

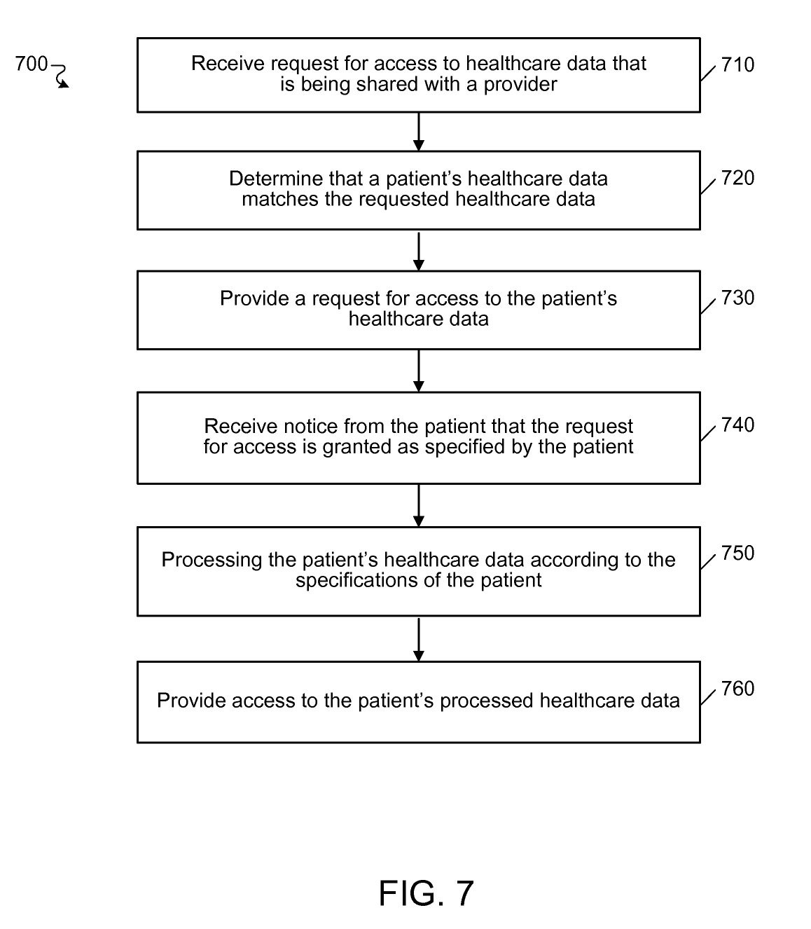

FIG. 7 is a flow chart of an example process 700 for an open healthcare data platform. In general, the process 700 shares healthcare related data that is being shared with a healthcare provider with a third party. The process 700 will be described as being performed by a computer system comprising one or more computers, for example, the healthcare information database 115 as shown in FIG. 1.

The system receives, from a third party, a request for access to healthcare related data that is associated with one or more healthcare related parameters (710). The one or more healthcare related parameters may include a type of data or particular demographics for the user. For example, the third party may specify blood sugar data for women ages 18-49. In some implementations the request includes a summary of a user for the healthcare related data. For example, the third party may include a summary that describes that the healthcare related data will be used to perform a diabetes study. In some implementations, the request includes a level of compensation to provide to users who have healthcare related data that matches the one or more parameters and who agree to share the healthcare related data with the third party. For example, the third party may offer to pay user's two dollars per week for each week that the user provides healthcare related data.

The system determines that a user's personal healthcare related data that is shared with a healthcare provider that provides services to the user corresponds to the one or more healthcare related parameters (720). At the time of the request, the user is already sharing the user's healthcare related data to a healthcare provider of the user. For example, the user's doctor may have requested the user to begin collecting blood sugar data twice a day. The user collects the information and either the user, or the glucometer, uploads the blood sugar reading to the system for the user's doctor to view. Other examples of personal healthcare related data include data received from a pedometer, data received from a scale, data received from a blood pressure monitor, data received from a pulse monitor, and data received from a thermometer. With healthcare related data such as the user's blood sugar data, the system identifies the healthcare related data that matches the one or more healthcare related parameters.

The system, based on determining that the user's personal healthcare related data that is shared with the healthcare provider that provides services to the user corresponds to the one or more healthcare related parameters, provides, to the user, a request for access to the user's personal healthcare related data that is shared with the healthcare provider (730). The system may provide the request through email, text, telephone, a healthcare related application, or through another messaging application. The system may also provide the request to the user when the user logs into the system to view the user's healthcare account. The system may add an icon to the user's main interface or dashboard that indicates the opportunity to share the user's healthcare related data.

The system receives, from the user, data indicating an acceptance of the request for access to the user's personal healthcare related data that is shared with the healthcare provider and data indicating a level of abstraction to apply to the user's personal healthcare related data that is shared with the healthcare provider (740). The level of abstraction applied by the user allows the user to select the personal healthcare related data to share with the third party. For example, the user may select to share the user's gender and geographic location, but request that the system remove the user's name and age. In some implementations, the user may request that the healthcare related data pass through a filter before the system shares the user's personal healthcare related data with the third party. For example, the user may select to share the user's blood sugar data on a weekly basis while the third party requested daily blood sugar information. The filters are typically in a periodic basis. For example, the user may select to share blood sugar on a daily, weekly, semi-weekly, monthly, biweekly, hourly, or any other periodic period.

The system processes the user's personal healthcare related data that is shared with the healthcare provider according to the level of abstraction (750). The system leaves the underlying data complete so that the user's healthcare provider still has access to the user's full healthcare related data, or at least, the healthcare related data that the user's healthcare provider requested the user to begin collecting. As an example of applying the level of abstraction, the system may remove the user's race, name, and geographic information from the user's personal healthcare information.

The system provides, to the third party, the processed user's personal healthcare related data that is shared with the healthcare provider (760). The system may receive another request from a fourth party for healthcare related data according to the same healthcare related parameters. The system identifies the user as having personal healthcare related data that corresponds to the healthcare related parameters. The fourth party's purpose for accessing the personal healthcare related data may be different than or the same as the third party's. The user may select a different level of abstraction to apply to the user's personal healthcare related information. For example, the user may select to share the user's age instead of only sharing the user's gender and geographic location. The system then processes the user's personal healthcare related data according to the new level of abstraction and provides the processed personal healthcare related data to the fourth party.

In some implementation, the system may be extended to other types of personal data that is already shared with an individual. For example, the system may collect diagnostic information for a car and share the data with the car owner's mechanic. A third party may then request diagnostic information for cars. If the car owner's data matches the information request, then the car owner may select to share the diagnostic information with the third party. Another example may include food that a user eats.

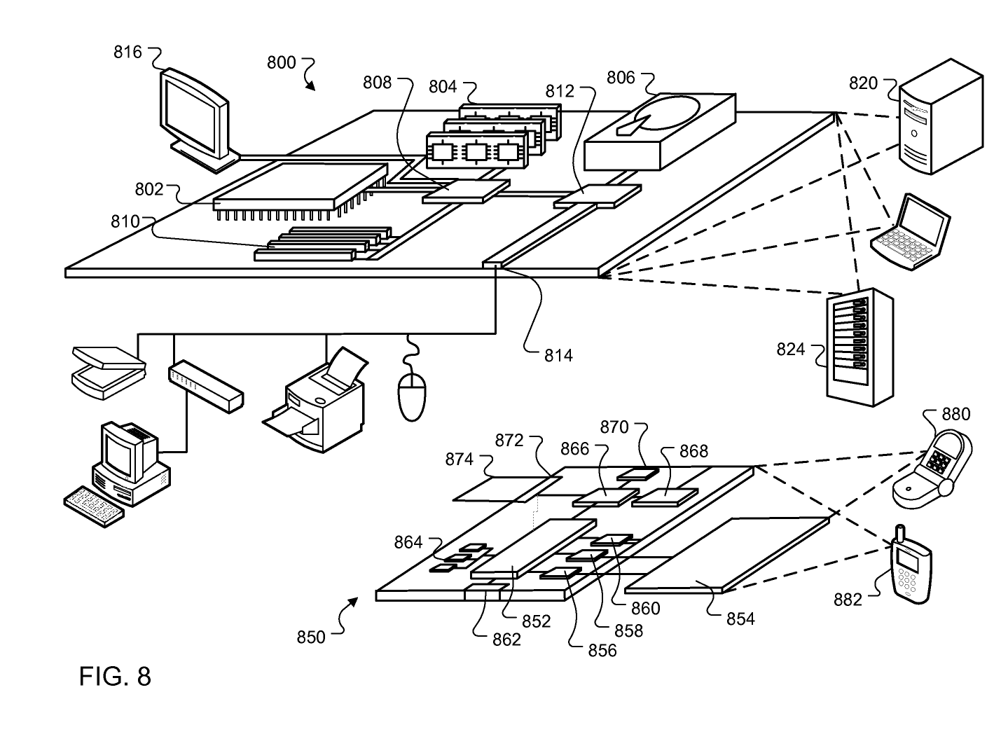

FIG. 8 shows an example of a computing device 800 and a mobile computing device 850 that can be used to implement the techniques described here. The computing device 800 is intended to represent various forms of digital computers, such as laptops, desktops, workstations, personal digital assistants, servers, blade servers, mainframes, and other appropriate computers. The mobile computing device 850 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 804 stores information within the computing device 800. In some implementations, the memory 804 is a volatile memory unit or units. In some implementations, the memory 804 is a non-volatile memory unit or units. The memory 804 may also be another form of computer-readable medium, such as a magnetic or optical disk.

The storage device 806 is capable of providing mass storage for the computing device 800. In some implementations, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 802), perform one or more methods, such as those described above. The instructions can also be stored by one or more storage devices such as computer- or machine-readable mediums (for example, the memory 804, the storage device 806, or memory on the processor 802).

The high-speed interface 808 manages bandwidth-intensive operations for the computing device 800, while the low-speed interface 812 manages lower bandwidth-intensive operations. Such allocation of functions is an example only. In some implementations, the high-speed interface 808 is coupled to the memory 804, the display 816 (e.g., through a graphics processor or accelerator), and to the high-speed expansion ports 810, which may accept various expansion cards (not shown). In the implementation, the low-speed interface 812 is coupled to the storage device 806 and the low-speed expansion port 814. The low-speed expansion port 814, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. In addition, it may be implemented in a personal computer such as a laptop computer 822. It may also be implemented as part of a rack server system 824. Alternatively, components from the computing device 800 may be combined with other components in a mobile device (not shown), such as a mobile computing device 850. Each of such devices may contain one or more of the computing device 800 and the mobile computing device 850, and an entire system may be made up of multiple computing devices communicating with each other.

The mobile computing device 850 includes a processor 852, a memory 864, an input/output device such as a display 854, a communication interface 866, and a transceiver 868, among other components. The mobile computing device 850 may also be provided with a storage device, such as a micro-drive or other device, to provide additional storage. Each of the processor 852, the memory 864, the display 854, the communication interface 866, and the transceiver 868, are interconnected using various buses, and several of the components may be mounted on a common motherboard or in other manners as appropriate.

The processor 852 can execute instructions within the mobile computing device 850, including instructions stored in the memory 864. The processor 852 may be implemented as a chipset of chips that include separate and multiple analog and digital processors. The processor 852 may provide, for example, for coordination of the other components of the mobile computing device 850, such as control of user interfaces, applications run by the mobile computing device 850, and wireless communication by the mobile computing device 850.

The processor 852 may communicate with a user through a control interface 858 and a display interface 856 coupled to the display 854. The display 854 may be, for example, a TFT (Thin-Film-Transistor Liquid Crystal Display) display or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may provide communication with the processor 852, so as to enable near area communication of the mobile computing device 850 with other devices. The external interface 862 may provide, for example, for wired communication in some implementations, or for wireless communication in other implementations, and multiple interfaces may also be used.

The memory 864 stores information within the mobile computing device 850. The memory 864 can be implemented as one or more of a computer-readable medium or media, a volatile memory unit or units, or a non-volatile memory unit or units. An expansion memory 874 may also be provided and connected to the mobile computing device 850 through an expansion interface 872, which may include, for example, a SIMM (Single In Line Memory Module) card interface. The expansion memory 874 may provide extra storage space for the mobile computing device 850, or may also store applications or other information for the mobile computing device 850. Specifically, the expansion memory 874 may include instructions to carry out or supplement the processes described above, and may include secure information also. Thus, for example, the expansion memory 874 may be provide as a security module for the mobile computing device 850, and may be programmed with instructions that permit secure use of the mobile computing device 850. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 852), perform one or more methods, such as those described above. The instructions can also be stored by one or more storage devices, such as one or more computer- or machine-readable mediums (for example, the memory 864, the expansion memory 874, or memory on the processor 852). In some implementations, the instructions can be received in a propagated signal, for example, over the transceiver 868 or the external interface 862.

The mobile computing device 850 may communicate wirelessly through the communication interface 866, which may include digital signal processing circuitry where necessary. The communication interface 866 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 868 using a radio-frequency. In addition, short-range communication may occur, such as using a Bluetooth, WiFi, or other such transceiver (not shown). In addition, a GPS (Global Positioning System) receiver module 870 may provide additional navigation- and location-related wireless data to the mobile computing device 850, which may be used as appropriate by applications running on the mobile computing device 850.

The mobile computing device 850 may also communicate audibly using an audio codec 860, which may receive spoken information from a user and convert it to usable digital information. The audio codec 860 may likewise generate audible sound for a user, such as through a speaker, e.g., in a handset of the mobile computing device 850. Such sound may include sound from voice telephone calls, may include recorded sound (e.g., voice messages, music files, etc.) and may also include sound generated by applications operating on the mobile computing device 850.

The mobile computing device 850 may be implemented in a number of different forms, as shown in the figure. For example, it may be implemented as a cellular telephone 880. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A computer-implemented method comprising:
receiving, from a third party, a request for access to healthcare related data that is associated with one or more healthcare related parameters;
determining that a user's personal healthcare related data that is shared with a healthcare provider that provides services to the user corresponds to the one or more healthcare related parameters;
based on determining that the user's personal healthcare related data that is shared with the healthcare provider that provides services to the user corresponds to the one or more healthcare related parameters, providing, to the user, a request for access to the user's personal healthcare related data that is shared with the healthcare provider;
receiving, from the user, data indicating an acceptance of the request for access to the user's personal healthcare related data that is shared with the healthcare provider and data indicating a level of abstraction to apply to the user's personal healthcare related data that is shared with the healthcare provider;
processing the user's personal healthcare related data that is shared with the healthcare provider according to the level of abstraction; and
providing, to the third party, the processed user's personal healthcare related data that is shared with the healthcare provider.

2. The method of claim 1, wherein the request for access to healthcare related data that is associated with one or more healthcare related parameters comprises:
a summary of a use for the healthcare related data, and
a level of compensation to provide to users who provide the healthcare related data.

3. The method of claim 1, wherein the one or more healthcare related parameters includes a category of the healthcare related data and a level of detail that specifies a frequency of collection of the category of the healthcare related data.

4. The method of claim 1, wherein the data indicating a level of abstraction to apply to the user's personal healthcare related data that is shared with the healthcare provider comprises data indicating whether to include the user's name, the user's demographic information, and the user's geographic location with the user's personal healthcare related data that is shared with the healthcare provider.

5. The method of claim 1, wherein the user's personal healthcare related data that is shared with the healthcare provider comprises:
data received from a pedometer;
data received from a blood sugar monitor;
data received from a scale;
data received from a blood pressure monitor;
data received from a pulse monitor; and
data received from a thermometer.

6. The method of claim 1, wherein the data indicating the acceptance of the request for access to the user's personal healthcare related data that is shared with the healthcare provider comprises data indicating a filter to apply to the user's personal healthcare related data according to a periodic frequency.

7. The method of claim 1, comprising:
receiving, from a fourth party, an additional request for access to healthcare related data that is associated with the one or more healthcare related parameters;
providing, to the user, an additional request for access to the user's personal healthcare related data that is shared with the healthcare provider;
receiving, from the user, data indicating an acceptance of the additional request for access to the user's personal healthcare related data that is shared with the healthcare provider and data indicating a second, different level of abstraction to apply to the user's personal healthcare related data that is shared with the healthcare provider;
processing the user's personal healthcare related data that is shared with the healthcare provider according to the second, different level of abstraction; and
providing, to the fourth party, the user's personal healthcare related data that is shared with the healthcare provider and that is processed according to the second, different level of abstraction.

8. The method of claim 1, wherein:
the user's personal healthcare related data that is shared with the healthcare provider is received from a quantified self device, and
the data indicating the acceptance of the request for access to the user's personal healthcare related data that is shared with the healthcare provider and data indicating a level of abstraction to apply to the user's personal healthcare related data that is shared with the healthcare provider is received from the quantified self device.

9. A system comprising:
one or more computers and one or more storage devices storing instructions that are operable, when executed by the one or more computers, to cause the one or more computers to perform operations comprising:
receiving, from a third party, a request for access to healthcare related data that is associated with one or more healthcare related parameters;
determining that a user's personal healthcare related data that is shared with a healthcare provider that provides services to the user corresponds to the one or more healthcare related parameters;
based on determining that the user's personal healthcare related data that is shared with the healthcare provider that provides services to the user corresponds to the one or more healthcare related parameters, providing, to the user, a request for access to the user's personal healthcare related data that is shared with the healthcare provider;
receiving, from the user, data indicating an acceptance of the request for access to the user's personal healthcare related data that is shared with the healthcare provider and data indicating a level of abstraction to apply to the user's personal healthcare related data that is shared with the healthcare provider;
processing the user's personal healthcare related data that is shared with the healthcare provider according to the level of abstraction; and
providing, to the third party, the processed user's personal healthcare related data that is shared with the healthcare provider.

10. The system of claim 9, wherein the request for access to healthcare related data that is associated with one or more healthcare related parameters comprises:
a summary of a use for the healthcare related data, and
a level of compensation to provide to users who provide the healthcare related data.

11. The system of claim 9, wherein the one or more healthcare related parameters includes a category of the healthcare related data and a level of detail that specifies a frequency of collection of the category of the healthcare related data.

12. The system of claim 9, wherein the data indicating a level of abstraction to apply to the user's personal healthcare related data that is shared with the healthcare provider comprises data indicating whether to include the user's name, the user's demographic information, and the user's geographic location with the user's personal healthcare related data that is shared with the healthcare provider.

13. The system of claim 9, wherein the user's personal healthcare related data that is shared with the healthcare provider comprises:
data received from a pedometer;
data received from a blood sugar monitor;
data received from a scale;
data received from a blood pressure monitor;
data received from a pulse monitor; and
data received from a thermometer.

14. The system of claim 9, wherein the data indicating the acceptance of the request for access to the user's personal healthcare related data that is shared with the healthcare provider comprises data indicating a filter to apply to the user's personal healthcare related data according to a periodic frequency.

15. The system of claim 9, wherein the operations further comprise:
receiving, from a fourth party, an additional request for access to healthcare related data that is associated with the one or more healthcare related parameters;
providing, to the user, an additional request for access to the user's personal healthcare related data that is shared with the healthcare provider;
receiving, from the user, data indicating an acceptance of the additional request for access to the user's personal healthcare related data that is shared with the healthcare provider and data indicating a second, different level of abstraction to apply to the user's personal healthcare related data that is shared with the healthcare provider;
processing the user's personal healthcare related data that is shared with the healthcare provider according to the second, different level of abstraction; and
providing, to the fourth party, the user's personal healthcare related data that is shared with the healthcare provider and that is processed according to the second, different level of abstraction.

16. The system of claim 9, wherein:
the user's personal healthcare related data that is shared with the healthcare provider is received from a quantified self device, and
the data indicating the acceptance of the request for access to the user's personal healthcare related data that is shared with the healthcare provider and data indicating a level of abstraction to apply to the user's personal healthcare related data that is shared with the healthcare provider is received from the quantified self device.

17. A non-transitory computer-readable medium storing software comprising instructions executable by one or more computers which, upon such execution, cause the one or more computers to perform operations comprising:
receiving, from a third party, a request for access to healthcare related data that is associated with one or more healthcare related parameters;
determining that a user's personal healthcare related data that is shared with a healthcare provider that provides services to the user corresponds to the one or more healthcare related parameters;
based on determining that the user's personal healthcare related data that is shared with the healthcare provider that provides services to the user corresponds to the one or more healthcare related parameters, providing, to the user, a request for access to the user's personal healthcare related data that is shared with the healthcare provider;
receiving, from the user, data indicating an acceptance of the request for access to the user's personal healthcare related data that is shared with the healthcare provider and data indicating a level of abstraction to apply to the user's personal healthcare related data that is shared with the healthcare provider;
processing the user's personal healthcare related data that is shared with the healthcare provider according to the level of abstraction; and
providing, to the third party, the processed user's personal healthcare related data that is shared with the healthcare provider.

18. The medium of claim 17, wherein the request for access to healthcare related data that is associated with one or more healthcare related parameters comprises:
a summary of a use for the healthcare related data, and
a level of compensation to provide to users who provide the healthcare related data.

19. The medium of claim 17, wherein the data indicating a level of abstraction to apply to the user's personal healthcare related data that is shared with the healthcare provider comprises data indicating whether to include the user's name, the user's demographic information, and the user's geographic location with the user's personal healthcare related data that is shared with the healthcare provider.

20. The medium of claim 17, wherein:
the user's personal healthcare related data that is shared with the healthcare provider is received from a quantified self device, and
the data indicating the acceptance of the request for access to the user's personal healthcare related data that is shared with the healthcare provider and data indicating a level of abstraction to apply to the user's personal healthcare related data that is shared with the healthcare provider is received from the quantified self device.
